(19) United States
(12) Patent Application Publication
(10) Pub. No.: US 2004/0064213 A1
(43) Pub. Date: Apr. 1, 2004

(54) Method and system for managing the color quality of an output device

(76) Inventors: Dirk Vansteenkiste, De Pinte (BE); Stefan Livens, Wijnegem (BE); Marv Mahy, Wilsele (BE)

Correspondence Address: Robert A. Sabourin, Agfa Corporation, Patent Department, 200 Ballardvale Street, Wilmington, MA, 01887, US

(21) Appl. No.: 10/467,846

(22) PCT Filed: Jan. 17, 2002
(86) PCT No.: PCT/EP02/00508

(30) Foreign Application Priority Data
Feb. 21, 2001 (EP) 01000025.5

(51) Int. Cl. G06F 19/00

(52) U.S. Cl. 700/108

(57) ABSTRACT

A method and a system are described for managing the color quality of a calibrated output device. Measurement data from a strip output by the output device are analyzed. Based on the analysis, either it is indicated that the output device matches a reference output device, or a probable cause is indicated why the output device does not match the reference output device.

The application claims the benefit of U.S. Provisional Application No. 60/296,128 filed Jul. 6, 2001 and U.S. Provisional Application No. 60/336,880 filed Dec. 3, 2001.

### FIELD OF THE INVENTION

The present invention relates to the field of image rendering by means of output devices, particularly multicolor proofing devices and more particularly multicolor ink-jet proofing devices; the invention especially concerns the consistency of the output of these devices over time and between different devices.

### BACKGROUND OF THE INVENTION AND DEFINITION OF TERMS

A “colorant” designates in this document an independent variable with which an output device can be addressed. A “colorant value”, denoted as c, is an independent value that can be used to control a colorant of the output device. The colorants of an offset printing press, for example, are the offset printing inks. It is customary to express the range of physically achievable values for the colorants of a device in %, which means that usually the colorant values range from c=0% to c=100%. In graphic arts, colorant values are often called dot percentages. An output device with n colorants, wherein n≧1, will also be called below a “printer” or an “n-ink process”. The output device may be a multicolor output device such as a CMYK offset printing press with a cyan (C), a magenta (M), a yellow (Y) and a black (K) colorant. The output device may also be e.g. a color display, photofinishing equipment (whole sale finishing (WSF) or minilab), a slide maker.

A “colorant space” is an n-dimensional space wherein n is the number of independent variables that are used to address the printer. In the case of an offset printing press, the dimension of the colorant space corresponds to the number of inks of the press.

A “color space” is a space that represents a number of quantities of an object that characterize its color. In most practical situations, colors will be represented in a 3-dimensional space that reflects some characteristics of the human visual system, such as CIE XYZ space (see “The Reproduction of Colour in Photography, Printing & Television” by R. W. G. Hunt, Fountain Press, England, fourth edition, 1987, ISBN 0 85242 356 X, sections 8.4 and 8.5 for CIE XYZ; this book is referenced to below as [Hunt]). However, other characteristics can also be used, such as multispectral values that are determined by means of a set of color filters; a typical example is an m-dimensional space of which the axes correspond to densities.

A “colorant gamut” or “colorant domain” is the delimited space in colorant space of the colorant combinations that are physically realizable by a given printer.

To specify a color, in most cases standard color spaces such as CIE XYZ or CIELAB are used. In this way colors are represented independently of a given color recording or reproduction technology. Hence these values are called “device independent” color values. If these values are represented in a space, a “device independent color space” is obtained.

However, in a lot of applications it is also possible to specify colors according to the color mixing technology of a given device. Examples are, for output devices, monitor RGB values (i.e. Red Green Blue) or offset CMYK values. On the other hand, several input devices are available to record scenes, such as digital cameras and scanners; here customarily the colors are identified with RGB triples. In all these examples, colors are specified according to the color mixing behavior of the input or output device. These coordinate systems will be referred to as “device dependent color spaces”; the color values are “device dependent color values”.

To print colors that are represented in a device independent color space, such as CIE XYZ and CIELAB, conversions have to be made from such a space to the colorant space of the corresponding printer, e.g. from CIELAB space to CMYK space. This involves characterization of the printer. “Characterization” of a printer is concerned with modeling the printer so as to predict the printer's output color values as a function of the input colorant values for the printer. To characterize a printer, typically a characterization target consisting of color patches is printed by the printer; the patches are then measured, e.g. by means of a spectrophotometer or a calorimeter. The color patches are usually defined in the colorant space of the printer; a typical example of a characterization target for a CMYK process is the IT8.7/3 target. Characterization is also called “profiling”, which means creating a file of data (a profile) that contains pairs of corresponding color values and colorant values for the device. An often used profile format is the ICC profile format that meets the ICC standard; the ICC is the International Color Consortium.

Before a printer is characterized, it is first “calibrated”, which means that the printer is put in a standard state. In fact, a printer can drift away from its standard state; e.g. changes in room humidity or use of a fresh supply of ink may cause a printer to produce different color. The objective of device calibration, therefore, is to bring a device back to a known, standard state, so that it produces predictable color every time it receives the same input colorant values. On the other hand, the object of printer characterization is not to change the device, but to describe how it works.

To calibrate a printer, typically a calibration target is printed by the printer and measured. If the measurements indicate that the printer has drifted away from its standard state, Tone Reproduction Curves (TRC's), also called calibration curves, are calculated from the measurement results to correct for this drift. A TRC transforms a colorant value to another colorant value. In case of a CMYK printer, four TRC's are needed to calibrate the output device. For a color monitor, only three TRC's are required.

In most cases, calibration is done by checking the 1-ink processes. These are the colors obtained by varying the value of just one colorant and setting the other colorant values to zero.

However, nowadays several ink-jet printers make use of multi-density inks to increase the apparent resolution. Typically, one yellow and one black shade are available, but two shades of cyan and magenta, i.e. a light version and a heavy version. These inks are combined together to obtain one cyan and one magenta channel. Hence, such a 6-ink printer is reduced to a 4-ink printer. The mixing of the light and heavy version of an ink to obtain one global ink value is done by so called Ink Mixing Tables (IMT). For printers with multi-density inks, preferably not only the TRC's but also the IMT's are involved in the calibration process.

A “Color Management System” (CMS) is a system, normally implemented at least partly in software, that helps the user to provide color consistency and predictability. To make e.g. certain colors remain the same from display through printing is not easy, because of the differing technologies for display and printing. A CMS may comprise a characterization table and calibration curves.

We refer to patent application EP 1 083 739, which is included herein by reference, for more information on calibration of both conventional CMYK printers and multi-density printers, and for more information on characterization, color gamut and other relevant terms.

The object of calibrating an output device is to compensate for changes that influence the output of the device. Ensuring the consistency of the output is especially important for multicolor proofing devices, since proofing, especially contract proofing, is extremely color-critical.

In contract proofing, the behavior of one printing process, e.g. a press standard or a particular press, is simulated on another process, a proofing device such as an ink-jet printer. Crucial to the success of proofing is that the proofing device, also called “proofer” below, produces reliable results. More precisely, for a given input it should always produce exactly the same, well defined output.

As the rendition of precise colors is pursued, the demands for consistent and predictable color quality are very high. This makes proofing much more color-critical than many other printing applications where one is mainly concerned with producing pleasing images. Moreover, proofing quality is generally judged by the worst match encountered. This also stresses the importance of a very tight control on the printed output.

When a predefined tonal behavior can be guaranteed over time, it becomes possible to create identical proofs over and over again. The obtained consistency eliminates the need for making new profiles that compensate for temporal changes. If a single common condition can also be enforced for different proofers at various locations, consistent output can be obtained everywhere. As a result, several printers can share the same profile which can simplify workflows. The consistency over different printers is also the key to successful remote contract proofing. In “remote” proofing, digital data representing the image that has to be proofed is sent over a communication link to a proofer that may be situated at any location.

A problem in attaining consistency is that many variables, both system and environmental ones, can cause significant variations in the output. Suppose the proofer is an ink-jet printer. Ink-jet technology, just like any other printing technology, makes use of mechanical and electrical components and chemical substances. The mechanical parts can differ from one printer to another, they are subject to wear and tear and possible failure, as are the electrical ones. The ink, as a chemical, will typically change its interaction when changes in the environment occur. This makes ink-jet printing especially vulnerable to changes in conditions such as temperature and humidity. Ink replacements can also have a profound impact on the output. The same is true for the “receiving substrate”, onto which the ink is deposited. The receiving substrate is usually paper, but other materials such as polyethylene coated paper, transparency film, etc. may also be used. Below, the term “paper” is generally used, but it is understood that in the present document the term “paper” means other types of receiving substrate as well. Both the ink and the paper are crucial to the output. Changes can occur even between different batches of supposedly identical paper. It goes without saying that true alterations to ink or paper, either deliberately or by mistake, will also cause different outputs. The same is true for the various settings of the printer and all software involved. A well-known problem in ink-jet printing is that nozzles of the ink-jet head can gradually clog up due to drying ink. Regularly cleaning the heads solves this, but this cannot guarantee that the output will be identical at all times. The rapid evolution of ink-jet technology results in ever increasing quality of the output, but at the same time, the printing requires higher precision components and the challenges for consistency only grow.

Calibration of the output device can compensate for changes influencing the consistency of the output of the device, but calibration demands quite some work.

Patent application EP 1 026 893 discloses a method for using feedback and feedforward in generating predictable reproducible presentation images in a distributed digital image processing system, that includes one or more output devices. When the presentation image is outputted by one or more of the output devices, measured characteristics of the presentation image are fed back to the appropriate output device and the output device can then automatically re-calibrate itself through the use of the measured characteristics. Alternatively, feedback information from output devices is used to inform a customer, an operator, or an automatic control device of the state and properties of an output device, to modify the image at some stage in processing in order to accommodate the state and properties of the output device, and/or to change the state of the output device to produce a presentation image that matches the image appearing at the image originating device.

In order to ensure the consistency of the color quality of a calibrated output device, an improved system is needed.

### SUMMARY OF THE INVENTION

The present invention is a method and system as claimed in respectively independent claims 1 and 49. Preferred embodiments of the invention are set out in the dependent claims. Preferably, a method in accordance with the invention is implemented by a computer program.

The invention involves verifying the quality of the output of a calibrated output device, preferably a calibrated proofer. A strip that is output by the calibrated output device is analyzed. Based upon the analysis, possible problems are pointed out and, if there is a problem, the user is prompted to perform suitable actions in order to restore the quality.

Thus, the user can quickly check if the output of the output device is OK; if the output is not OK, the probable cause of the problem is indicated to the user.

A first advantage of having a verification apart from the calibration is that the required user effort is decreased considerably. In practice, it is very much undesired that one has to recalibrate the output device every time a consistent quality is needed, since this requires quite some work. A first factor that decreases the required user effort is that in the verification preferably only a small, fixed control strip is output and measured, which is much less laborious than a recalibration. A “strip” contains at least one patch; preferably, a strip contains a fixed set of color patches. In a preferred embodiment, the control strip is printed in the border of the paper. In another embodiment, the control strip may be contained in the printed image, or one or more patches may be interspersed throughout the image. A second factor that decreases the required user effort is that, in a preferred embodiment, the invention is implemented in a computer program, and that the measurement process is preferably integrated within this computer program; this makes the verification an easy process. The integration also ensures that settings may be automatically controlled and logged.

An additional advantage of the invention is that the behavior of the output device is more stable, thanks to the separate verification. In fact, as long as the output of the output device is consistent, recalibration will actually increase the variation in the output. To calibrate a printer, typically a calibration target is printed by the printer and measured by a measurement device such as a spectrophotometer. The measurement results of this measurement device unavoidably contain some uncertainty. Unnecessary recalibration is in fact overcorrection, which often causes stable systems to deviate more than they would if left alone. Also, some deviations in output cannot be corrected for in the calibration, although they can be detected.

Yet another advantage of the invention is that a probable cause of the problem is indicated if the verification shows that the output of the output device is not consistent any more. Thus, the problem can be quickly remedied. Some examples of causes of problems are a wrong setting of the proofer such as wrong driver settings; a mistake in the workflow; use of a wrong profile; use of an improper ink, i.e. an ink that does not correspond to the installed profile; use of an improper paper. After the probable cause of the problem is indicated, the user can take an appropriate action. Such an interactive approach offers a very good chance to solve the problem.

In the verification, a strip is output by the output device. Measurement data of the strip are obtained, either by means of a measurement device, such as a spectrophotometer or a calorimeter, or manually, as discussed below. In a preferred embodiment of the invention, reference data are obtained from a reference output device and the obtained measurement data and reference data are analyzed. Based on the analysis, either a probable cause is indicated why the output device does not match the reference output device, or it is indicated that the output device matches the reference output device. That two devices “match” means that they produce the same output within given tolerances. How these tolerances are determined is discussed further below (under the “Detailed description of the invention”).

As mentioned above, the measurement data may be obtained manually, e.g. by comparing portions of the strip with a set of standard color patches, such as patches from the Munsell color atlas. This method of working takes time but is quite accurate, since the human eye is very sensitive to color differences.

The “reference output device” referred to above may be a physical output device such as another proofer; it may also be a theoretical output device that corresponds to a set of reference data. A first example of such a theoretical output device is a device corresponding to reference data that are made up from data of a plurality of output devices, e.g. by averaging data from the plurality of output devices. These output devices are preferably calibrated. For instance, measurement data of a strip output by a calibrated proofer of a certain type may be compared with the average of the measurement data of five proofers of that type, which is taken as the reference. Alternatively, a calibrated proofer may be compared to a theoretical output device made up from data of output devices of another type. A second example of a theoretical output device is a press standard such as TR001; this second example is discussed further below.

In a first aspect of the invention, it is verified if an output device, preferably a proofer, is stable over time; if it is not, a probable cause is indicated why the output device is not stable over time. Some embodiments of this first aspect of the invention are now discussed.

Under a preferred embodiment, measurement data of a strip are obtained at a point in time t₁ from the output device that has to be verified. These measurement data and reference data are analyzed. The reference data are taken as the reference in time for the output device that is verified; they correspond to a theoretical output device that the output device should match “at initial time t₀”. For instance, the reference data may be based on averaged measurement data from five output devices of the same type as the output device that is verified, so that these reference data constitute the target for the output device. From the analysis of the measurement data and the reference data it can be verified if the output device still matches the reference output device, and is thus stable over time, or not. Optionally, other measurement data may also be analyzed, such as measurement data obtained from the output device at a point in time t₂ after the point in time t₁.

Under another embodiment, the reference output device is the calibrated output device itself, and the reference data were obtained from the output device itself. Thus, both the reference data and measurement data originate from the calibrated output device, but at two different points in time. From the analysis of the measurement data and reference data it is indicated if the output device is stable over time. The data at the two different points in time may be obtained by outputting strips by the output device at the two different points in time and by measuring the strips.

In a second aspect of the invention, it is verified if two output devices, preferably two calibrated proofers, match. If the two output devices do not match, a probable cause is indicated why they don't match. The second output device may be located remotely from the first one. The second output device may be of a different type or manufacturer than the first one. Some embodiments of this second aspect of the invention are now discussed.

Under a preferred embodiment, both the first and the second output device are compared to a reference output device. If the first output device matches the reference output device and the second output device matches the reference output device, than the first output device matches the second one. The reference output device is preferably a theoretical output device that is taken as the reference for the first and second output devices. Preferably, measurement data from the first output device and reference data from the reference device on the one hand, and measurement data from the second output device and reference data from the reference output device on the other hand are analyzed to determine if the first output device matches the second one. The measurement data from the first and second output devices may be obtained from strips printed by these devices.

Under another embodiment, the two output devices are directly compared to each other, i.e. the reference output device is a printing device with which the first output device is compared. Comparing the two output devices may be done by analyzing measurement data from a first and a second strip outputted by respectively the first and the second output device. An interesting example of this embodiment is a case of newspaper proofing. A certain type of newspaper stock, for which reference data are not yet available, is proofed on a first calibrated proofer, located e.g. at the east coast of the USA. A strip is printed on this type of newspaper stock and measured. Based on these measurement data, reference data and optionally additional data are determined and stored in a file. On a second calibrated proofer, located remotely from the first one, e.g. at the west coast of the USA, a strip is printed on the same type of newspaper stock. Measurement data of the latter strip and the reference data are analyzed to check if both proofers match when proofing on this type of newspaper stock. The reference data can also be used to check, later, if the first calibrated proofer is stable over time, when proofing on this type of newspaper stock.

In a third aspect of the invention, it is verified if a printing device, preferably an offset printing press, matches another output device, preferably a proofer. If the printing device and the other output device do not match, a probable cause is indicated why they don't match. The printing device may be located remotely from the other output device. Some embodiments of this third aspect of the invention are now discussed.

Under a preferred embodiment, the behavior of a proofer and an output device such as an offset printing press are compared, which is called below “proof to print” verification. Preferably, verifying if the proofer matches the offset printing press is done by analyzing measurement data from a first and a second strip printed by respectively the proofer and the offset printing press.

Under another embodiment, the proofer is compared to a press standard, such as TR001, which is standard SWOP. Instead of simulating the offset printing press on the proofer, while taking into account the profile of the offset printing press, the standard TR001 profile is taken into account to check if the proofer correctly matches the TR001 standard; if this is not the case, a probable cause of the problem is indicated.

Preferably, a method in accordance with the invention is implemented by a computer program running on a computer. Such a computer program may be on a computer readable medium. Another embodiment of the invention is a data processing system that includes means for carrying out the steps of a method in accordance with the invention.

Another embodiment of the invention is a system comprising a calibrated output device, analyzing means and indicating means. A strip is output by the output device. Measurement data of the strip and reference data of a reference output device are analyzed by the analyzing means. Based on the analysis, the indicating means indicates either that the calibrated output device matches the reference output device, or it indicates a probable cause why the devices do not match. The analyzing means and the indicating means may be implemented by a computer and a computer program for the computer. Preferably, the calibrated output device is a proofer. The system may also include a measurement device, such as an X-Rite DTP41 spectrophotometer, to obtain the measurement data of the strip. In a specific embodiment, the measurement device is incorporated in the output device. A plurality of measurement devices may be used, e.g. in case of remote proofing where two or more proofers are located remotely with respect to each other.

Preferred embodiments of a system in accordance with the invention may include features of a method—as claimed or as described above or below—in accordance with the invention.

Further advantages and embodiments of the present invention will become apparent from the following description.

### DETAILED DESCRIPTION OF THE INVENTION

In order to be able to detect the cause of problems, we collected a large amount of experimental data of the printed output during a period of one month. Along with the measurement data, we kept rigorous track of all factors that might influence the printed result. By analyzing this data we were able to correlate the measured variations in the output with different events in the external factors. We have found that different external factors correspond to output variations that are distinct in direction, magnitude, or both.

This makes it possible to differentiate between various types of problems, and thus to indicate the probable cause of a problem, by analyzing measurement data of a printed strip. In this way the verification of the output quality—at least the detection of the cause of a problem—can become an automatic procedure, that can be implemented in a computer program.

The analysis of measurement data of a printed strip preferably includes evaluating the measured variations in direction and magnitude and comparing them with tolerance levels. The tolerance levels have to be fixed properly. In a preferred embodiment, the tolerance levels are based on statistical data, such as the experimental data collected during a period of one month as mentioned above. More information about tolerance levels is given below, especially under the so-called “proof to proof verification”; this information is also applicable to other embodiments of the invention than the proof to proof verification. The measured variations, that are compared to the tolerance levels, are preferably the differences between the measurement data of the printed strip and reference data. As discussed above, the reference data may be obtained in different ways; they may e.g. be based on the average of the measurement data from a plurality of output devices of a certain type.

We have developed a system that identifies what causes most likely correspond to what variations; preferably such system is a knowledge based system. In a preferred embodiment the system also takes into account the effort required to fix the problem, given its cause; this system uses the following logical principle: maximize the chance of fixing the problem with the minimal effort necessary.

Preferably, the system is a cascading one. The actions can be ordered more or less hierarchically according to the effort required to perform them. We have found out that the most frequently occurring problems are often the less serious ones. An initial guess is made of the best level to attack the problem. When two causes are equally probable, first that cause is suggested that corresponds to an action on the lower level, i.e. an action requiring less effort. After the action on the lower level is performed, the new result is evaluated. If the deviation is not solved, a new action on a higher level is suggested.

The following illustrates such a cascading system. Suppose a single patch of a verification strip shows a deviation—perhaps the patch got damaged, e.g. by dirt or by a fingerprint. In that case, remeasuring the verification strip may solve the problem; possibly we have to go to a higher level and reprint the strip before remeasuring it. If the readings of a complete strip are out of line, but those of the other strips are fine, perhaps the strip was read in wrongly. Then, the best guess is to remeasure the strip, there is no evidence that it needs to be reprinted. If remeasurement however turns out to be ineffective, one might need to go to a higher level after all and reprint the strip. If this does not solve the problem, the system may then decide that one has to go to a still higher level and recalibrate the printer. If none of these solutions can bring the printer into a standard condition, yet higher level actions are proposed such as checking if the paper type is correct. If all else fails, the system might resort to suggesting having the printer serviced.

The advantages of having such a cascading system are very clear. The user has a systematic approach at hand for solving his problem. The encountered deviations are interpreted by the system in such a way that chances are increased to attack the problem directly at the right level, so that many useless tests can be skipped and time is saved. The servicing engineers will only be called in if all other efforts have failed. In a preferred embodiment of the invention, they can directly look into the data recorded during the previous tests, which also helps them in their work. Preferably, they also have access to the rest of the recorded history of the printer.

In a preferred embodiment, fresh printouts are used and a fixed time is observed before measuring a printout. It is preferred that a strip used for verification is measured 15 minutes after printing. A preferred measurement device is an X-Rite DTP41 spectrophotometer, on which the strip can be measured automatically and conveniently. Moreover, when using the X-rite DTP41, the measurement process can be integrated within a computer program implementing the invention. Other measurement devices may also be used, as well as visual assessment, as discussed above. The operational procedures regarding timing of the measurements serve to counteract the effect of time on the output. Ink-jet prints are often subject to aging effects, especially due to fading. On the other hand, ink typically needs to dry for some time before the final result is obtained.

A system in accordance with the invention can support all types of input systems, monitors, printers. Applications may be offset printing, packaging, proofing for newspaper, poster printing and imposition, just to name a few. In case of a workflow, it is preferred that the set-up of all devices within the workflow is evaluated and also relations between them if necessary. Take for example conventional and digital proofing. In case of conventional proofing, color separations are printed on film. With the film, the conventional proof is generated and the plates for the offset press are made. Hence the transformation of the image data to film, i.e. Computer To Film (CTF), from film to proof and to plate, and from plate to paper have to be checked. In fact, every copy of the image to another medium may introduce an error. In case of digital proofing, the digital image is sent to a proofer such as an ink-jet printer on the one hand and to film/plate on the other hand for the offset press. For the offset press, the image transformation for the CTF and from film to plate, or for the Computer To Plate system (CTP) has to be checked.

An advantage of the invention is that the result is checked and that in between steps are preferably only verified is case something is wrong. This verification is guided by the system, as explained above, so as to find the problem very quickly and easily.

As different devices, users, applications and workflows require different settings, in a preferred embodiment dedicated information is stored in a kind of info files for a given workflow. The dedicated information may include characteristics of certain types of films and plates, characteristics of inks and papers for output devices, and different functionalities for different users, to name a few. Since systems may change over time, there is prefererably also a procedure to obtain information on the state of the devices. For output systems, as discussed above it is preferred that control strips containing a fixed set of color patches are printed and measured. The measurements of several control strips over time may be stored in special data files. These files can be accessed to get information on the device. As discussed above, either the device characteristics may be checked with respect to a standard color behavior or with respect to another color reproduction device, or the evolution in time of the device itself may be checked.

As mentioned above, a system in accordance with the invention may be used for different applications. When applied to digital proofing, the invention may support one or more of the following functions:

calibration: generation of calibration curves for the proofer;

proof to proof verification: check the calibration and characterization of proofers; check that a proofer is functioning properly; check that it is performing identically over a period of time; check that two or more proofers are performing equally—e.g. that a proofer in a remote location is performing equally to a proofer in a main facility;

proof to print verification: verification of the behavior of an offset system with respect to a proofer; verification of the standard state of a given offset system.

Preferred embodiments of calibration, proof to proof verification and proof to print verification are now discussed more in detail.

The calibration procedure generates TRC's, IMT's or both. For conventional CMYK printers, TRC's are used. For printers with multi-density inks, preferably IMT's are used, possibly in combination with TRC's. For a given printer, the calibration is controlled by a file per ink/paper combination, called the ink-file. The ink-file contains different parameters required to make the calibration curves. The calibration can be done in different ways. For a detailed discussion of different calibration methods, we refer to patent application EP 1 083 739; only some aspects of calibration are set out here. Concerning the maximum amount of ink applied to the paper, often the maximum useful or desired amount of ink is less than the maximum amount that is technically possible. It is convenient to incorporate this as an “ink limitation” into the calibration. While the printed output for the maximum amount of ink is determined by the ink limitation, the tonal behavior for all intermediate values can still vary. This can be solved by regularization, which is the construction of a calibration function in such a way that a fixed correspondence between the image data and the measured quantities results. The correspondence does not necessarily have to be made linear. There are however distinct advantages to linearity, e.g. regarding stability and optimal use of available levels. This explains why regularization often equals linearization, and we use linearization as another term for calibration, even if the calibration does not result in a linear correspondence between image data and measured quantities. As disclosed in patent application EP 1 083 739, the quantity that is measured is preferably CIE lightness L* for cyan, magenta and black ink, and CIE chroma C* for yellow ink.

Preferably, the proper color patches to calculate the calibration curves are specified by the ink-file. A preferred embodiment of the invention may not only include making the calibration curves, but also evaluating the measurements made for the calibration procedure and, in case of problems, issuing proper warnings and error messages to the user.

The proof to proof verification may allow one or more of the following functions.

In a first mode, called “calibration check”, it is checked if the target values for the calibration are still valid, taking into account predefined tolerances. If something is wrong, the printer may have to be recalibrated. The target values for the calibration are found in the ink-file for a given ink/paper combination and driver settings.

A second mode is called “verification consumables”. For the proofer, a reference profile was generated and installed that contains the basic characteristics of the printer. The reference profile depends on the type of proofer, on the specific ink/paper combinations, on the driver settings. In the mode “verification consumables”, the calorimetric values of a number of color patches are analyzed to check if the proper inks and papers are used. The reference profile contains the characteristics of these color patches. If inks and/or papers are detected that do not correspond to the installed profile, a warning is given.

In a third mode, called “characterization check”, a combination of the inks is evaluated. If a given value does not agree with the proper color values corresponding to the most recent profile for the given printer, a new profile has to be made. In the beginning, the above-mentioned reference profile contains the characteristics for this check. However, if later on the proofer does not perform according to the reference profile, a custom profile may have to be used. Such a custom profile can e.g. be made using the ColorTune™ software of Agfa-Gevaert N.V.

Based on these checks, the proper warnings and error signals may be provided.

An example of a calibration check is as follows. A proof to proof consistency control strip is printed by the proofer. This strip comprises four patches for each of the colors C, M, Y and K. For each of these patches, a consistency score “score_{P}” is calculated, that is positive or zero:

score_{P}=1−0.05*delta/tolerance if this value is >0,

score_{P}=0 otherwise

wherein “delta” is the absolute value of the difference between the target value and the measured value in CIE lightness L* for a cyan, magenta or black patch, and in CIE chroma C* for a yellow patch; and wherein “tolerance” is a predetermined tolerance value, based on statistical data for the printer, as disclosed above.

For each color, a combined score “score_{C}”, that is positive or zero, is calculated from the consistency scores score_{P1}, score_{P2}, score_{P3} and score_{P4} of the four patches of the concerned color:

score_{C}=0.9+⁴\sqrt{(score_{P1}−0.9)*(score_{P2}−0.9)*(score_{P3}−0.9)*(score_{P4}−0.9)}

if all four consistency scores are ≧0.9, and

score_{C}=0 if at least one consistency score <0.9.

Based on the consistency scores score_{P} and the combined scores score_{C} the following messages may be given to the user, divided into three stages. Since the messages of stage 1 may be quite numerous, preferably only the messages of stages 2 and 3 are given to the user.

Stage 1:

| | Consistency | |
|---|---|---|
| Case | score | Message |
| 1 | ≧99% | The printed output patch matches the target |
| | | patch completely |
| 2 | 97-99% | There are minor deviations between the printed |
| | | output patch and the target patch |
| 3 | 95-97% | The printed output is still acceptable but the |
| | | deviations between target patch and output patch |
| | | are significant |
| 4 | 93-95% | The printed output patch is unacceptable; there |
| | | are large deviations between target patch and |
| | | output patch |
| 5 | <93% | The printed output patch is unacceptable; there |
| | | are very large deviations between target patch |
| | | and output patch |

Stage 2:

| Case | Condition | Message |
|---|---|---|
| A | If for color X, the combined | There is a major |
| | score scoreC <95%; | problem with color X |
| B | else if for more than one patch | There is a problem with |
| | scorep <95%; | color X |
| C | else if for one patch | Color X has a bad value |
| | scorep <95%. | |

Stage 3:

| Condition | Message |
|---|---|
| If case A | Make sure the printer is in optimal condition (no |
| occurs | clogged nozzles, head-alignment OK, . . . ) |
| | If the problem persists after cleaning, reprinting |
| | and remeasuring, recalibrate the proofer. If this |
| | does not solve the problem, contact a service |
| | technician. |
| If case B | Check the strip for artifacts (banding, . . . ) |
| occurs | Make sure the printer is in optimal condition (no |
| | clogged nozzles, head-alignment OK, . . . ) |
| | If the problem persists after cleaning, reprinting |
| | and remeasuring, consider recalibrating the proofer. |
| If case C | Check the strip for artifacts: fingerprints, stains, |
| occurs | stripes, banding, . . . |
| | Consider remeasuring the current strip, or printing |
| | a new strip and measuring it. In case of banding, |
| | cleaning the print head may solve the problem. |

A preferred embodiment for the verification of consumables includes the following evaluations. The measurement of patches, ranging from 0% to 100% for a certain ink, yields a unique path in CIELAB space. Under density variations of the colorants, this calorimetric path is fairly stable; only the endpoint of the path will vary. Such variations of colorant densities can occur e.g. when more or less ink is applied to the paper, e.g. due to clogged nozzles. To verify the used consumables, a first calorimetric path is determined that corresponds to reference data and a second calorimetric path that corresponds to measurement data of the ink/paper combination that has to be verified. Then, the distance between the first and the second paths is determined. This distance may be calculated by taking some fixed points on the first path and calculating, for each of these fixed points, the distance to the nearest point on the second path. The distance between the paths is

What is claimed, is:

1. A quality management method comprising:
obtaining measurement data of a strip output by a calibrated output device;
obtaining reference data from a reference output device;
analyzing said measurement data and said reference data;
indicating, based on said analysis
A. that said output device matches said reference output device; or
B. a probable cause why said output device does not match said reference output device.

2. The quality management method according to claim 1 wherein said output device is a proofer.

3. The quality management method according to claim 1 wherein said reference output device is a press standard.

4. The quality management method according to claim 1, further comprising outputting said strip by depositing an ink on a receiving substrate.

5. The quality management method according to claim 4, further comprising checking, based on said analysis, if said ink is a proper ink.

6. The quality management method according to claim 4, further comprising checking, based on said analysis, if said receiving substrate is a proper receiving substrate.

7. The quality management method according to claim 1 wherein said reference data are made up from data from a plurality of calibrated output devices.

8. The quality management method according to claim 7 wherein said reference data are an average of data from said plurality of calibrated output devices.

9. The quality management method according to claim 2 wherein said reference data are made up from data from a plurality of calibrated output devices.

10. The quality management method according to claim 9 wherein said reference data are an average of data from said plurality of calibrated output devices.

11. The quality management method according to claim 1 wherein said measurement data include a CIE L* value.

12. The quality management method according to claim 2 wherein said measurement data include a CIE L* value.

13. A data processing system comprising means for carrying out the method according to claim 1.

14. A computer program comprising computer program code means adapted to perform the method according to claim 1 when said program is run on a computer.

15. A computer readable medium comprising program code adapted to carry out the method according to claim 1 when run on a computer.

16. A data processing system comprising means for carrying out the method according to claim 2.

17. A computer program comprising computer program code means adapted to perform the method according to claim 2 when said program is run on a computer.

18. A computer readable medium comprising program code adapted to carry out the method according to claim 2 when run on a computer.

19. A quality management method comprising:
obtaining measurement data of a strip output by a calibrated output device;
obtaining reference data from a reference output device, wherein said reference data are a reference in time for said output device;
analyzing said measurement data and said reference data;
indicating, based on said analysis
A. that said output device is stable over time; or
B. a probable cause why said output device is not stable over time.

20. The quality management method according to claim 19 wherein said reference output device is said first output device and wherein the method further comprises:
obtaining said reference data from said first output device by measuring another strip output by said first output device at a point in time t₁;
outputting said strip for obtaining said measurement data at a point in time t₂ after said point in time t₁.

21. The quality management method according to claim 19 wherein said reference data are made up from data from a plurality of calibrated output devices.

22. The quality management method according to claim 20 wherein said reference data are made up from data from a plurality of calibrated output devices.

23. The quality management method according to claim 19 wherein said measurement data include a CIE L* value.

24. The quality management method according to claim 20 wherein said measurement data include a CIE L* value.

25. A data processing system comprising means for carrying out the method according to claim 19.

26. A computer program comprising computer program code means adapted to perform the method according to claim 19 when said program is run on a computer.

27. A computer readable medium comprising program code adapted to carry out the method according to claim 19 when run on a computer.

28. A quality management method comprising:
obtaining measurement data of a strip output by a first, calibrated, proofer;
obtaining reference data from a second, calibrated, proofer, different from said first, calibrated, proofer;
analyzing said measurement data and said reference data;
indicating, based on said analysis
A. that said first proofer matches said second proofer; or
B. a probable cause why said first proofer does not match said second proofer.

29. The quality management method according to claim 28 wherein said second proofer is located remotely from said first proofer.

30. The quality management method according to claim 28 further comprising:
obtaining said reference data by measuring a second strip printed on said second proofer.

31. The quality management method according to claim 28 wherein said measurement data include a CIE L* value.

32. A data processing system comprising means for carrying out the method according to claim 28.

33. A computer program comprising computer program code means adapted to perform the method according to claim 28 when said program is run on a computer.

34. A computer readable medium comprising program code adapted to carry out the method according to claim 28 when run on a computer.

35. A quality management method comprising:
obtaining first measurement data of a strip output by a first, calibrated, proofer;
obtaining reference data from a reference output device;
making a first analysis of said first measurement data and said reference data;
obtaining second measurement data from a second, calibrated, proofer, different from said first proofer;
making a second analysis of said second measurement data and said reference data;
indicating, based on said first and said second analysis
A. that said second proofer matches said first proofer; or
B. a probable cause why said second proofer does not match said first proofer.

36. The quality management method according to claim 35 wherein said reference data are made up from data from a plurality of calibrated output devices.

37. The quality management method according to claim 35 wherein said measurement data include a CIE L* value.

38. A data processing system comprising means for carrying out the method according to claim 35.

39. A computer program comprising computer program code means adapted to perform the method according to claim 35 when said program is run on a computer.

40. A computer readable medium comprising program code adapted to carry out the method according to claim 35 when run on a computer.

41. A quality management method comprising:
obtaining measurement data of a strip output by a calibrated output device;
obtaining reference data from an offset printing press;
analyzing said measurement data and said reference data;
indicating, based on said analysis
A. that said output device matches said offset printing press; or
B. a probable cause why said output device does not match said offset printing press.

42. The quality management method according to claim 41 wherein said output device is a proofer.

43. The quality management method according to claim 41 further comprising obtaining said reference data by measuring a second strip printed on said offset printing press.

44. The quality management method according to claim 42 further comprising obtaining said reference data by measuring a second strip printed on said offset printing press.

45. The quality management method according to claim 41 wherein said measurement data include a CIE L* value.

46. A data processing system comprising means for carrying out the method according to claim 41.

47. A computer program comprising computer program code means adapted to perform the method according to claim 41 when said program is run on a computer.

48. A computer readable medium comprising program code adapted to carry out the method according to claim 41 when run on a computer.

49. A system comprising:
a calibrated output device for printing a strip;
an analyzing device for analyzing measurement data of said strip and reference data of a reference output device;
an indicator for indicating, based on said analysis of said measurement data and said reference data
A. that said calibrated output device matches said reference output device; or
B. a probable cause why said calibrated output device does not match said reference output device.

50. The system according to claim 49 wherein said calibrated output device is a proofer.

51. The system according to claim 49 further comprising a measurement device for obtaining said measurement data.

52. The system according to claim 50 further comprising a measurement device for obtaining said measurement data.
